(19) United States
(12) Patent Application Publication
(10) Pub. No.: US 2024/0426705 A1
(43) Pub. Date: Dec. 26, 2024

(54) SYSTEMS AND METHODS FOR ENABLING BLOWOUT PREVENTER SOAK TESTING

(71) Applicant: Aquila Engineering LLC, Houston, TX (US)

(72) Inventor: Jose Meraz, Houston, TX (US)

(21) Appl. No.: 18/755,056

(22) Filed: Jun. 26, 2024

Related U.S. Application Data
(60) Provisional application No. 63/510,232, filed on Jun. 26, 2023.

(51) Int. Cl. G01M 13/003; E21B 33/06

(52) U.S. Cl. CPC G01M 13/003; E21B 33/06

(57) ABSTRACT

Systems and methods presented herein enable blowout preventer soak testing. In particular, the systems and methods presented herein are configured to receive operational data in substantially real-time from equipment that is located at a worksite and that is being monitored by the real-time operations center and/or by one or more auxiliary devices in proximity of the equipment, to perform data analytics remotely on the operational data during operation of the equipment, wherein the data analytics relate to soak testing of a blowout preventer, and to provide one or more graphical user interfaces to one or more computing devices, wherein the one or more graphical user interfaces illustrate results of the soak testing.

### CROSS-REFERENCE TO RELATED APPLICATION

This application claims priority to and the benefit of U.S. Provisional Application No. 63/510,232, entitled “Systems and Methods for Enabling Blowout Preventer Soak Testing,” filed Jun. 26, 2023, which is hereby incorporated by reference in its entirety for all purposes.

### BACKGROUND

The present disclosure relates generally to systems and methods for real-time remote equipment monitoring and data analytics and, more specifically, to systems and methods for enabling blowout preventer soak testing.

Often, operating entities that own and/or operate equipment do not have the time and/or resources to monitor operational data for the equipment in an organized manner to enable real-time decision making relating to the operational data. As such, there is a need for systems and methods that enable such operating entities to leverage the intelligence and data analytics infrastructure of an outside entity that specializes in such real-time remote equipment monitoring and data analytics. In particular, there is a need for systems and methods that enable soak testing of blowout preventers.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In certain embodiments, an equipment monitoring system includes a real-time operations center configured to receive operational data in substantially real-time from equipment that is located at a worksite and that is being monitored by the real-time operations center and/or by one or more auxiliary devices in proximity of the equipment, to perform data analytics remotely on the operational data during operation of the equipment, wherein the data analytics relate to soak testing of a blowout preventer, and to provide one or more graphical user interfaces to one or more computing devices, wherein the one or more graphical user interfaces illustrate results of the soak testing.

In addition, in certain embodiments, a data analytics kiosk includes at least one processor and at least one memory medium, wherein the at least one processor is configured to execute computer-readable instructions stored in the at least one memory medium that, when executed by the at least one processor cause the data analytics kiosk to receive operational data in substantially real-time from equipment that is located at a worksite and that is being monitored by the data analytics kiosk and/or by one or more auxiliary devices in proximity of the equipment, to perform data analytics on the operational data during operation of the equipment, wherein the data analytics relate to soak testing of a blowout preventer, and to display one or more graphical user interfaces via a display of the data analytics kiosk, wherein the one or more graphical user interfaces illustrate results of the soak testing.

Various refinements of the features noted above may be undertaken in relation to various aspects of the present disclosure. Further features may also be incorporated in these various aspects as well. These refinements and additional features may exist individually or in any combination.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an overview of general functionalities of the systems and methods described herein with respect to equipment of interest, in accordance with embodiments the present disclosure;

FIG. 2 is a block diagram of an equipment monitoring system for real-time remote equipment monitoring and data analytics, in accordance with embodiments the present disclosure;

FIGS. 3A through 3C illustrate various auxiliary devices that may be used to collect operational data of equipment, in accordance with embodiments the present disclosure;

FIG. 4 is a perspective view of a data analytics kiosk having a display device configured to display a graphical user interface to communicate information relating to real-time monitoring and analysis of equipment, in accordance with embodiments the present disclosure;

FIG. 5 is a flow diagram of a method for utilizing the data analytics kiosk, in accordance with embodiments the present disclosure;

FIG. 6 illustrates a main user interface of a soak testing application, in accordance with embodiments the present disclosure;

FIGS. 7-29 illustrate various functionalities of the main user interface of the soak testing application of FIG. 6, in accordance with embodiments the present disclosure; and

FIG. 30 is a flow diagram of a method for enabling soak testing, in accordance with embodiments the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Further, to the extent that certain terms such as parallel, perpendicular, and so forth are used herein, it should be understood that these terms allow for certain deviations from a strict mathematical definition, for example to allow for deviations associated with manufacturing imperfections and associated tolerances.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “automatic” and “automatically” may refer to actions that are performed by a computing device or computing system (e.g., of one or more computing devices) without human intervention. For example, automatically performed functions may be performed by computing devices or systems based solely on data stored on and/or received by the computing devices or systems despite the fact that no human users have prompted the computing devices or systems to perform such functions. As but one non-limiting example, the computing devices or systems may make decisions and/or initiate other functions based solely on the decisions made by the computing devices or systems, regardless of any other inputs relating to the decisions.

As used herein, the terms “real time” and substantially real time” may refer to actions that are performed substantially simultaneously with other actions, without any human-perceptible delay between the actions. For example, two functions performed in substantially real time occur within seconds (or even within milliseconds) of each other. As but one non-limiting example, two functions performed in substantially real time occur within 1 second, within 0.1 second, within 0.01 second, and so forth, of each other.

As used herein, the term “application” may refer to one or more computing modules, programs, processes, workloads, threads, and/or computing instructions executed by a computing system. Example embodiments of an application include software modules, software objects, software instances, and/or other types of executable code.

As used herein, the term “cycle” may refer to one instance of a plurality of instances of repeated functions performed by certain equipment and/or individual components of the equipment. For example, if certain equipment and/or individual components of the equipment are configured to perform repeated tasks that are relatively similar, each instance of a repeated task may be referred to as a cycle of performance by the equipment and/or individual components of the equipment.

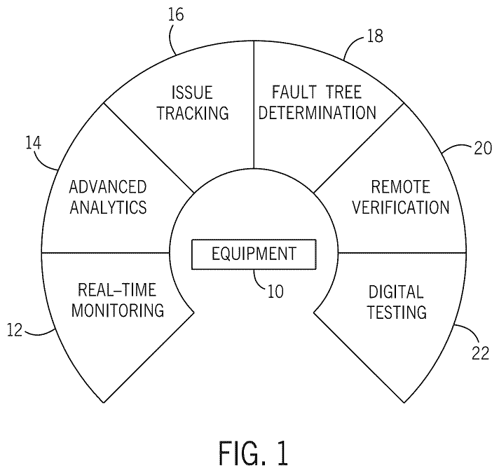

The embodiments described herein include systems and methods for real-time remote equipment monitoring and data analytics. FIG. 1 illustrates an overview of general functionalities of the systems and methods described herein with respect to equipment 10 of interest. As illustrated in FIG. 1, the systems and methods described herein include real-time monitoring 12 of the equipment 10 during operation of the equipment 10, advanced analytics 14 of data relating to operation of the equipment 10, issue tracking 16 relating to operation of the equipment 10, fault tree determination 18 relating to potential operational inefficiencies of the equipment 10, remote verification 20 of the integrity of the equipment 10, and digital testing 22 of the equipment 10, among other functionalities. Each of these general functionalities will be described in greater detail herein.

In general, the real-time monitoring 12 includes the functionality of providing an immersive graphical user interface configured to enable real-time monitoring of trends relating to operation of the equipment 10. In certain situations, the equipment 10 may be monitored by an industry expert. However, in other situations, artificial intelligence may be used to monitor the equipment 10, and to learn from the data over time such that insight into the operation of the equipment 10 that might otherwise be unattainable is achieved. Indeed, the advanced analytics 14 may provide custom-built equipment health analytics to track and alert users of operational statuses of the equipment 10, such as system performance degradation. In addition, the issue tracking 16 includes the functionality of tracking and documenting all equipment-related issues.

In addition, the fault tree determination 18 includes assessing the effects of all pending operational statuses, such as potential failures, availability, compliance with regulations, and so forth, relating to the equipment 10. In addition, the remote verification 20 of integrity of the equipment 10 may be enabled by the remote analytics and real-time management provided by the system. In addition, the digital testing 22 of the equipment 10 provides robust and reliable predictive software for testing the equipment 10.

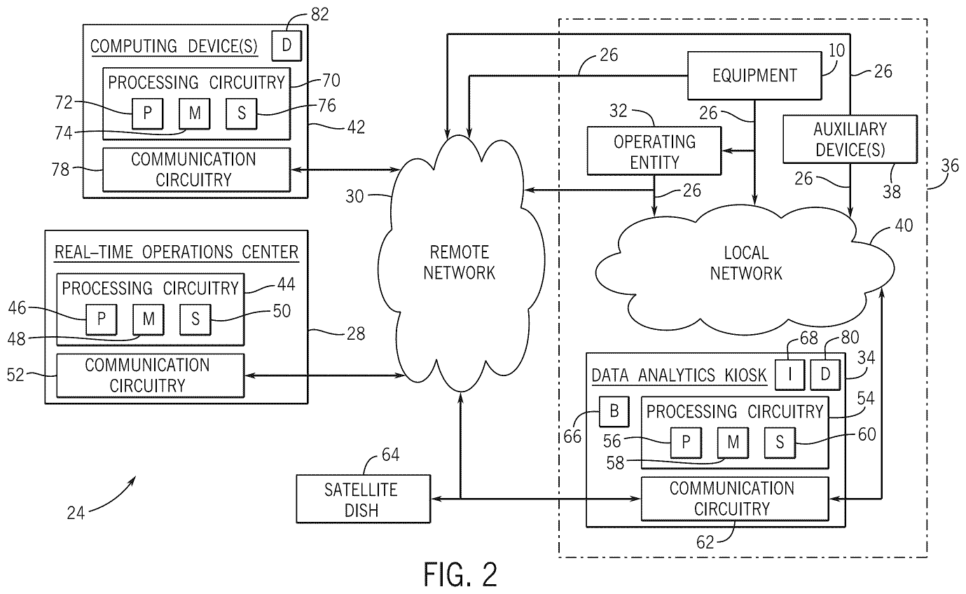

With the foregoing functionalities in mind, FIG. 2 is a block diagram of an equipment monitoring system 24 for real-time remote equipment monitoring and data analytics, as described in greater detail herein. As illustrated in FIG. 2, real-time operational data 26 relating to operational parameters of the equipment 10 may be generated during operation of the equipment 10, and may be transmitted to a real-time operations center 28, as described in greater detail herein, via a remote communication network 30. In certain embodiments, the remote communication network 30 may generally be a wireless communication network. However, in other embodiments, wired communication links may also be used as part of the remote communication network 30. In certain embodiments, the operational data 26 may be transmitted directly from the equipment 10 to the real-time operations center 28. However, in other embodiments, the operational data 26 may be transmitted from an operating entity 32 that owns and/or operates the equipment 10 to the real-time operations center 28.

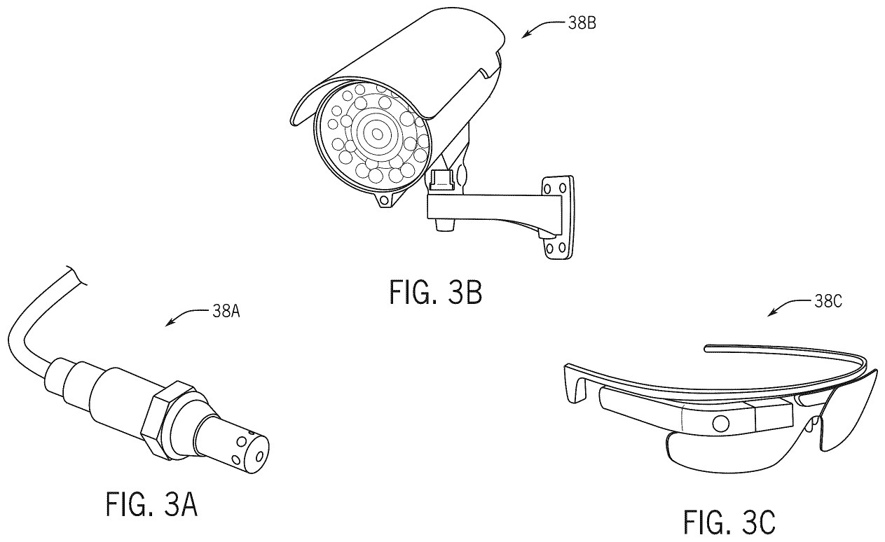

Furthermore, in certain embodiments, the operational data 26 may be collected by one or more auxiliary devices 38 operating in the vicinity of the equipment 10, and may be transmitted from the respective auxiliary device 38 to the real-time operations center 28. FIGS. 3A through 3C illustrate various auxiliary devices 38 that may be used to collect the real-time operational data 26 of the equipment 10. For example, in certain embodiments, the auxiliary devices 38 may include, but are not limited to, sensors 38A (e.g., pressure sensors, temperature sensors, and so forth) configured to directly sense operational parameters of the equipment 10, cameras 38B (e.g., fixed or portable cameras) configured to capture images and or video of operation of the equipment 10, wearable devices 38C (e.g., smart glasses or goggles, augmented reality glasses or goggles, and so forth) configured to capture images, video, audio, and so forth, of operation of the equipment 10, as well as other types of auxiliary devices 38.

In addition, in certain embodiments, a data analytics kiosk 34 may be located at a worksite 36 that includes the equipment 10, and may be used to communicate with the equipment 10, the operating entity 32, and/or the auxiliary devices 38 as an intermediary between the real-time operations center 28, the equipment 10, the operating entity 32, and/or the auxiliary devices 38, as described in greater detail herein. As described in greater detail herein, the real-time operations center 28 is located remotely from the worksite 36. In other words, the real-time operations center 28 is not located at the worksite 36, or even in the vicinity of the worksite 36. Indeed, the real-time operations center 28 may be located anywhere in the world, and may be used to collect and monitor real-time operational data 26 relating to many different pieces of equipment 10 located at many different worksites 36 all over the world.

In addition, in certain embodiments, the data analytics kiosk 34 may be configured to perform many of the functionalities of the real-time operations center 28, and may provide a convenient analytics terminal at the worksite 36 for equipment operators, as described in greater detail herein. Indeed, in certain embodiments, the real-time operational data 26 relating to the operational parameters of the equipment 10 may be transmitted to the data analytics kiosk 34 via a local communication network 40 that controls communications at the worksite 36. In other words, in certain embodiments, the real-time operational data 26 for the equipment 10 may be transmitted, in parallel, both to the real-time operations center 28, which is located remotely from the worksite 36, via the remote communication network 30, and to the data analytics kiosk 34, which is located locally on the worksite 36, via the local communication network 40. As such, if one of the networks 30, 40 experiences downtime, the other network 30, 40 may continue to transmit the real-time operational data 26 to one or both of the real-time operations center 28 and the data analytics kiosk 34, thereby providing redundancy of the transmission of the real-time operational data 26. In such embodiments, the real-time operations center 28 and the data analytics kiosk 34 may be configured to periodically synchronize the real-time operational data 26 collected by the respective devices. Indeed, in certain embodiments, the real-time operations center 28 and the data analytics kiosk 34 may be configured to store the real-time operational data 26 in cloud storage provided by the remote communication network 30. In addition, the data analytics kiosk 34, as well as the one or more computing devices 42, may be configured to display graphical user interfaces that include data, tables, graphs, and so forth relating to operation of the equipment 10, as described in greater detail herein.

As illustrated in FIG. 2, in certain embodiments, the real-time operations center 28 includes processing circuitry 44 that includes, for example, at least one processor 46, at least one memory medium 48, at least one storage medium 50, or any of a variety of other components that enable the processing circuitry 44 of the real-time operations center 28 to carry out the techniques described herein. For example, the at least one processor 46 is configured to execute computer-readable instructions stored in the at least one memory medium 48 and/or the at least one storage medium 50 that, when executed by the at least one processor 46 cause the real-time operations center 28 to perform the techniques described herein. In addition, in certain embodiments, the real-time operations center 28 may include communication circuitry 52 to facilitate the real-time operations center 28 to receive the operational data 26 from the equipment 10 and to communicate with the data analytics kiosk 34 and/or the one or more computing devices 42, as described in greater detail herein. In certain embodiments, the communication circuitry 52 may be configured to facilitate wireless communication and/or wired communication.

In addition, in certain embodiments, the data analytics kiosk 34 similarly includes processing circuitry 54 that includes, for example, at least one processor 56, at least one memory medium 58, at least one storage medium 60, or any of a variety of other components that enable the processing circuitry 54 of the data analytics kiosk 34 to carry out the techniques described herein. For example, the at least one processor 56 is configured to execute computer-readable instructions stored in the at least one memory medium 58 and/or the at least one storage medium 60 that, when executed by the at least one processor 56 cause the data analytics kiosk 34 to perform the techniques described herein. In addition, in certain embodiments, the data analytics kiosk 34 may include communication circuitry 62 to facilitate the data analytics kiosk 34 to receive the operational data 26 from the equipment 10 and to communicate with the real-time operations center 28 and/or the one or more computing devices 42, as described in greater detail herein. In addition, in certain embodiments, the communication circuitry 62 may include an antenna configured to facilitate the data analytics kiosk 34 to transmit data (e.g., operational data of the equipment 10 and/or results of the data analytics described herein) directly to a satellite dish 64, which may then be transmitted to external computing devices such as the real-time operations center 28 and/or the one or more computing devices 42, as described in greater detail herein. In certain embodiments, the communication circuitry 62 may be configured to facilitate wireless communication and/or wired communication.

In addition, in certain embodiments, the data analytics kiosk 34 may include a backup battery 66 configured to provide backup power for the data analytics kiosk 34 even when power is not available, or is not being provided, by the worksite 36. In addition, in certain embodiments, the data analytics kiosk 34 may include one or more audio and/or visual indicators 68 (e.g., speakers, light emitting diodes, and other types of indicators) configured to be activated (e.g., to make noises, flash, change color, and so forth) by the processing circuitry 54 of the data analytics kiosk 34 when certain alerts relating to operation of the equipment 10 are generated by the processing circuitry 54 based on the performed analytics described herein.

In addition, in certain embodiments, the one or more computing devices 42 similarly includes processing circuitry 70 that includes, for example, at least one processor 72, at least one memory medium 74, at least one storage medium 76, or any of a variety of other components that enable the processing circuitry 70 of the one or more computing devices 42 to carry out the techniques described herein. For example, the at least one processor 72 is configured to execute computer-readable instructions stored in the at least one memory medium 74 and/or the at least one storage medium 76 that, when executed by the at least one processor 72 cause the one or more computing devices 42 perform the techniques described herein. In addition, in certain embodiments, the one or more computing devices 42 may include communication circuitry 78 to facilitate the one or more computing devices 42 to communicate with the real-time operations center 28 and/or the data analytics kiosk 34, as described in greater detail herein. In certain embodiments, the communication circuitry 78 may be configured to facilitate wireless communication and/or wired communication.

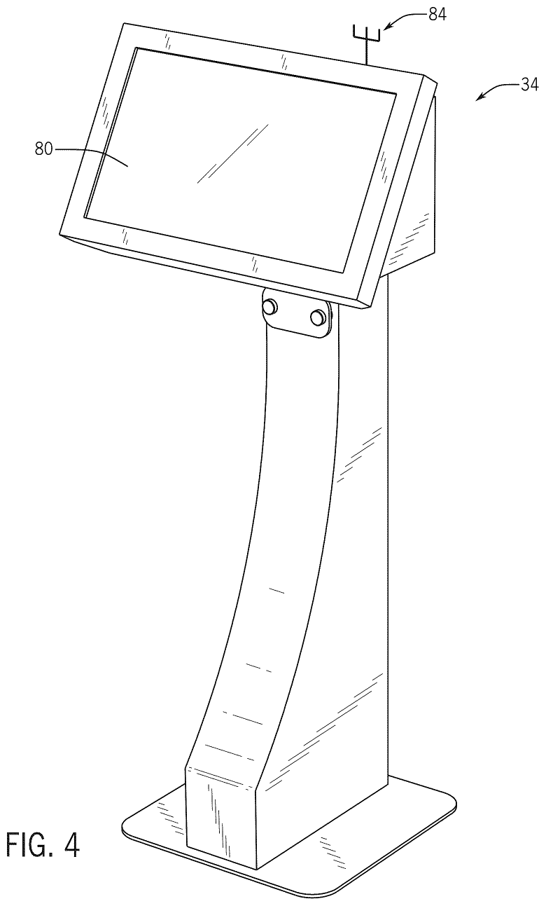

In addition, the data analytics kiosk 34 and the one or more computing devices 42 may be configured to display graphical user interfaces via respective display devices 80, 82 to communicate information relating to the real-time monitoring and analysis of the equipment 10, as described in greater detail herein. FIG. 4 is a perspective view of a data analytics kiosk 34 having a display device 80 configured to display a graphical user interface to communicate information relating to the real-time monitoring and analysis of the equipment 10, as described in greater detail herein. In addition, as illustrated in FIG. 4, the data analytics kiosk 34 may include an antenna 84 (e.g., as part of the communication circuitry 62 of the data analytics kiosk 34) configured to facilitate the data analytics kiosk 34 to transmit data (e.g., operational data of the equipment 10 and/or results of the data analytics described herein) directly to a satellite dish 64, which may then be transmitted to external computing devices such as the real-time operations center 28 and/or the one or more computing devices 42, as described in greater detail herein.

As illustrated in FIG. 4, the data analytics kiosk 34 may be a standalone computing device that, in certain embodiments, may be accessible for public use by operators that are working at a worksite 36, for example, on an offshore oil rig. As such, certain types of data may be accessible via the data analytics kiosk 34 by any and all operators that have access to the worksite 36. To that end, the data analytics kiosk 34 and the real-time operations center 28 may coordinate to determine certain data that is approved to be presented via the display device 80 of the data analytics kiosk 34 (e.g., that the displayable data is not restricted in any way). However, other types of data may be restricted to only certain operators at the worksite 36. In such situations, the data analytics kiosk 34 may include certain equipment (e.g., optical scanners) to determine when such restricted data may be presented via the display device 80 of the data analytics kiosk 34. For example, the equipment may scan an area immediately in front of the data analytics kiosk 34 to identify a particular operator (e.g., via facial recognition) and/or identify an identification card (e.g., by scanning a QR code on the identification card) associated with the particular operator to enable access to the particular operator to restricted data that might not otherwise be cacheable via the display device 80 of the data analytics kiosk 34. Even in such embodiments, the data analytics kiosk 34 may present some sort of authorization prompt via the display device 80 of the data analytics kiosk 34 to verify the presence of the particular operator and that the particular operator approves display of the restricted data via the display device 80 of the data analytics kiosk 34.

Returning now to FIG. 2, the real-time operations center 28 is configured to monitor operations of the equipment 10 in substantially real-time. In certain embodiments, an expert system is designed to efficiently monitor all of the trends of a control system associated with the equipment 10 and data analytics results performed by the real-time operations center 28. In certain embodiments, the real-time monitoring data may be secured with two-factor authentication. The real-time operations center 28 enables continuous surveillance and trending of the operational data 26 of the equipment 10. In addition, in certain embodiments, the real-time operations center 28 provides communication with operators at a worksite 36 regarding observed issues associated with the equipment 10.

In addition, in certain embodiments, the real-time operations center 28 provides a custom-built system to track and follow-up on all observed issues associated with the equipment 10. In particular, a variety of documented issues may be tracked over time including, but not limited to, failures, observations, original equipment manufacturer (OEM) communications, test histories, and so forth. In certain embodiments, the real-time operations center 28 may be configured to provide reliability metrics for the equipment 10. In addition, in certain embodiments, the real-time operations center 28 may be configured to generate documentation, schematics, and certifications relating to the equipment 10.

In addition, in certain embodiments, the real-time operations center 28 may be configured to determine fault trees for the equipment 10 to enable assessment of the effect of all ongoing issues relating to availability and compliance of the equipment 10. In particular, in certain embodiments, thousands of component models relating to the equipment 10 may be used by the real-time operations center 28. In certain embodiments, the real-time operations center 28 may be configured to provide automatic reporting for regulatory submissions relating to the equipment 10.

In addition, in certain embodiments, the real-time operations center 28 may be configured to track operational efficiency of the equipment 10. For example, in certain embodiments key performance indicators (KPIs) and timelines may be tracked in substantially real-time to enable monitoring of real-time operational statuses of the equipment 10. In addition, in certain embodiments, the real-time operations center 28 enables evaluation of testing performance.

In addition, in certain embodiments, the real-time operations center 28 may be configured to generate a variety of automated reports to clients, management, and regulatory agencies. For example, in certain embodiments, the real-time operations center 28 may be configured to automatically generate analysis reports, digital testing reports, periodic regulatory reports (e.g., quarterly Bureau of Safety and Environmental Enforcement (BSEE) reports), among other reports.

In addition, in certain embodiments, the real-time operations center 28 may be configured to provide maintenance tracking and optimization relating to the equipment 10 to enable users to follow maintenance activities for the equipment 10 and drive condition-based maintenance for the equipment 10 through the data analytics described herein. For example, in certain embodiments, the real-time operations center 28 may enable real-time tracking of maintenance tasks for the equipment 10 and may perform maintenance optimization analyses (MOA) for the equipment to, for example, provide a digital maintenance map.

In addition, in certain embodiments, the real-time operations center 28 may be configured to provide component-level health monitoring that tracks components of the equipment 10 to, for example, detect deviations from expected operational parameters. As such, degradation of the equipment 10 may be tracked and isolated for each individual component of the equipment 10. In certain embodiments, results of this analysis may be correlated to observed failures and may be used as the basis for condition-based maintenance for the equipment 10.

In addition, in certain embodiments, the real-time operations center 28 may be configured to provide custom-built event management that captures real-time events including analytic results, as described in greater detail herein. For example, in certain embodiments, real-time alerts may be generated based on events that are automatically detected by the real-time operations center 28. As such, the real-time operations center 28 may be configured to capture health and operational events for the equipment 10 and to, for example, provide automatic prioritization of the events.

The equipment 10 being monitored and analyzed in real-time, as described in greater detail herein, may include any type of equipment 10 configured to generate data relating to its operation. For example, the equipment 10 may include motors, pumps, compressors, electrical generators, heat exchangers, heating, ventilation, and air conditioning (HVAC) systems, blowers, fans, mixers/blenders, centrifuges, material handing equipment, valves, drilling rigs and other drilling equipment, and well control equipment (e.g., including blowout preventers (BOPs)), among other equipment. The examples described herein are primarily directed toward the monitoring and analysis of operational data 26 relating to a BOP. However, again, the embodiments described herein are not limited to the monitoring and analysis of BOPs. Rather, the embodiments described herein are configured to be applied to any and all types of equipment 10 operating in various applications and industries.

In certain embodiments, a variety of graphical user interfaces may be provided via the data analytics kiosk 34 and/or the one or more computing devices 42, for example, via an application being executed by the data analytics kiosk 34 and/or the one or more computing devices 42, respectively. Again, the example graphical user interfaces described below are primarily directed toward monitoring of BOPs. However, again, in other embodiments, the graphical user interfaces may be directed to monitoring of other types of equipment 10.

For example, in certain embodiments, as described in greater detail herein, a graphical user interface presented via a display 80, 82 of the data analytics kiosk 34 and/or the one or more computing devices 42 may relate to BOP soak testing. In certain embodiments, the real-time operations center 28 may be configured to provide in-depth, component-level monitoring of soak testing (e.g., pressure testing of a BOP control system). For example, in certain embodiments, the real-time operations center 28 may provide real-time tracking of pressure drops at different BOP sensing points, and may detect issues during the soak testing.

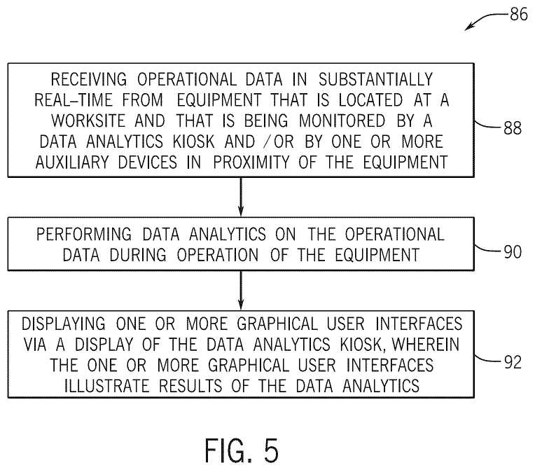

FIG. 5 is a flow diagram of a method 86 for utilizing the data analytics kiosk 34 described herein. As illustrated in FIG. 5, in certain embodiments, the method 86 includes receiving operational data in substantially real-time from equipment 10 that is located at a worksite 36 and that is being monitored by the data analytics kiosk 34 and/or by one or more auxiliary devices 38 in proximity of the equipment 10 (block 88). In addition, in certain embodiments, the method 86 includes performing data analytics on the operational data during operation of the equipment 10 (block 90). In addition, in certain embodiments, the method 86 includes displaying one or more graphical user interfaces via a display 80 of the data analytics kiosk 34, wherein the one or more graphical user interfaces illustrate results of the data analytics (block 92).

In addition, in certain embodiments, the method 86 includes identifying and tracking issues associated with operation of the equipment 10 over time. In addition, in certain embodiments, the method 86 includes determining one or more fault trees for the equipment 10. In addition, in certain embodiments, the method 86 includes tracking one or more operational efficiency indicators as they change over time. In addition, in certain embodiments, the method 86 includes generating one or more automated reports relating to operation of the equipment 10. In addition, in certain embodiments, the method 86 includes providing maintenance tracking and optimization relating to the equipment 10. In addition, in certain embodiments, the method 86 includes providing component-level health monitoring for one or more components of the equipment 10. In addition, in certain embodiments, the method 86 includes providing custom-built event management relating to events that occur during operation of the equipment 10. In addition, in certain embodiments, the method 86 includes providing one or more graphical user interfaces to one or more computing devices 42, wherein the one or more graphical user interfaces illustrate results of the data analytics. In addition, in certain embodiments, the method 86 includes transmitting the operational data and/or the results of the data analytics directly to a satellite dish 64.

As described in greater detail herein, the real-time operations center 28 and/or the data analytics kiosk 34 may be configured to execute software to enable operators (e.g., subsea operators, drilling operators, and so forth) of the real-time operations center 28 and/or the data analytics kiosk 34 to interact with a soak testing tool. In addition, the real-time operations center 28 and/or the data analytics kiosk 34 may enable the operators to create their own protocols during a soak testing operation. In particular, the soak testing application described herein is a dashboard to support subsea engineers during a soak test. The soak testing application described herein is primarily intended to be used for testing of a secondary BOP stack. As described in greater detail herein, the soak testing application enables users to: (1) visualize live data from a server (e.g., an OPC unified architecture (UA) server) that is connected to a secondary BOP, (2) provide analytics on pressure trends (e.g., as collected by a pressure data logger associated with the secondary BOP), and (3) save and recover results for later access and reporting.

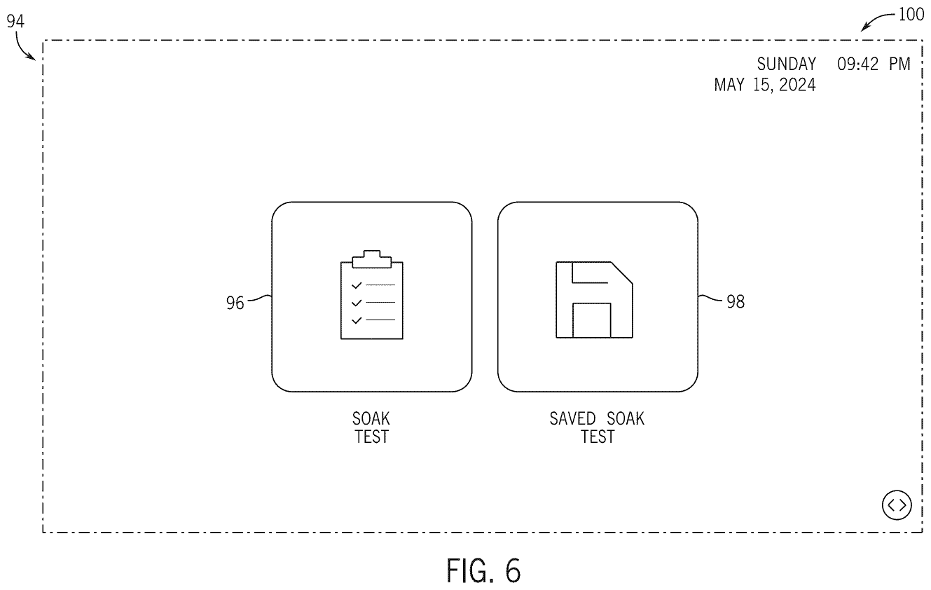

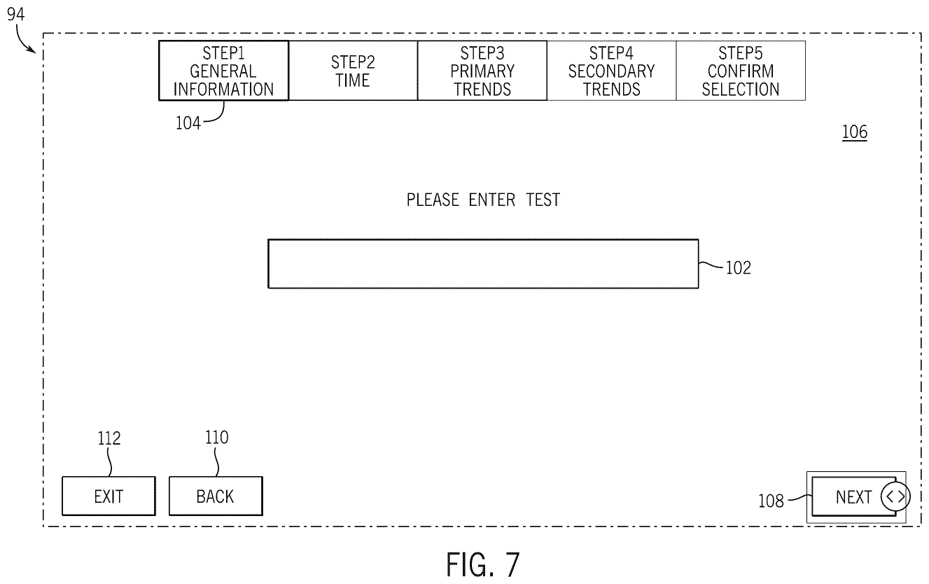

FIG. 6 illustrates the main user interface 94 of the soak testing application described herein, which enables a user to either start a new soak test by clicking on a Soak Test button 96 or load a previous soak test by clicking on a Saved Soak Test button 98. As illustrated, the time and date are also shown in the top right corner 100. As illustrated in FIG. 7, if a user elects to start a new soak test by clicking on the Soak Test button 96, the user may then enter a name for the soak test in an input box 102 as a first step in a General Information portion 104 of a Configuration process 106. As illustrated in FIG. 7, for each screen of the Configuration process 106, a Next button 108 moves to the next step, whereas a Back button 110 moves back to the previous step and an Exit button 112 exits the Configuration process 106 entirely.

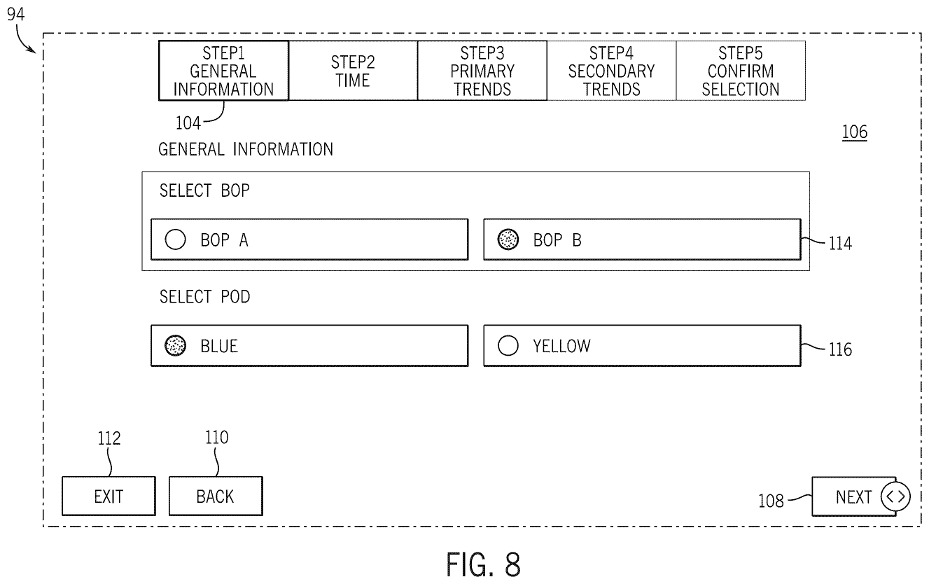

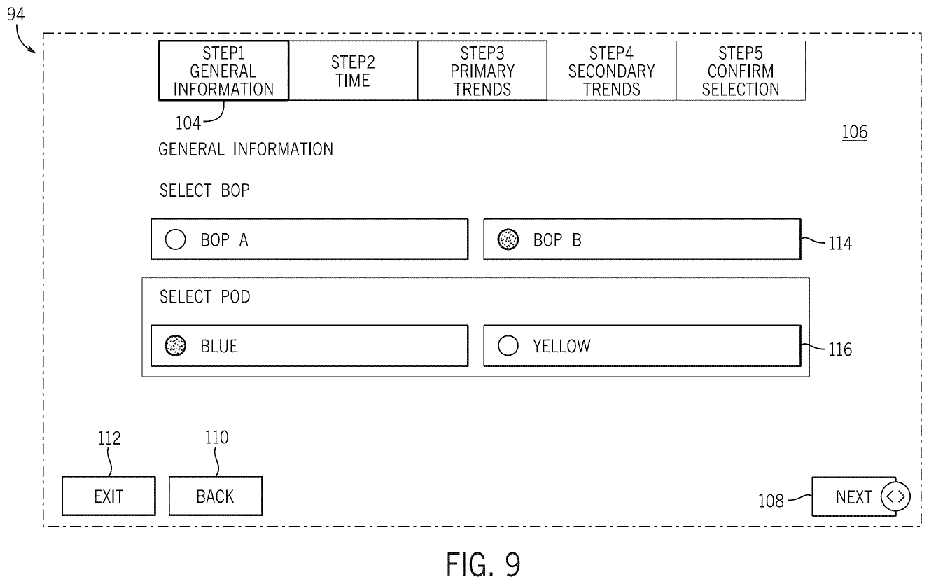

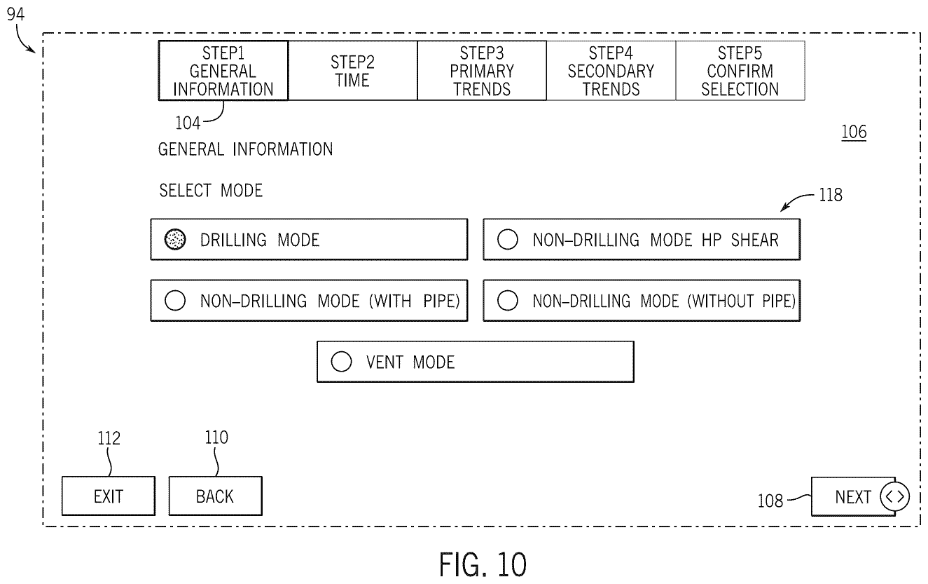

Once the soak test name has been entered, the user may select a BOP for the soak test with Select BOP radio buttons 114 (FIG. 8), as well as a BOP pod for the soak test with Select Pod radio buttons 116 (FIG. 9). Then, as illustrated in FIG. 10, once the BOP and BOP pod are selected, the user may select one of a plurality of soak test options (e.g., drilling modes) with Select mode radio buttons 118. In the illustrated embodiment, the soak test options (e.g., drilling modes) may include Drilling mode, Non-drilling mode HP shear, Non-drilling mode (with pipe), Non-drilling mode (without pipe), and Vent mode. However, other soak test options (e.g., drilling modes) may be utilized in other embodiments.

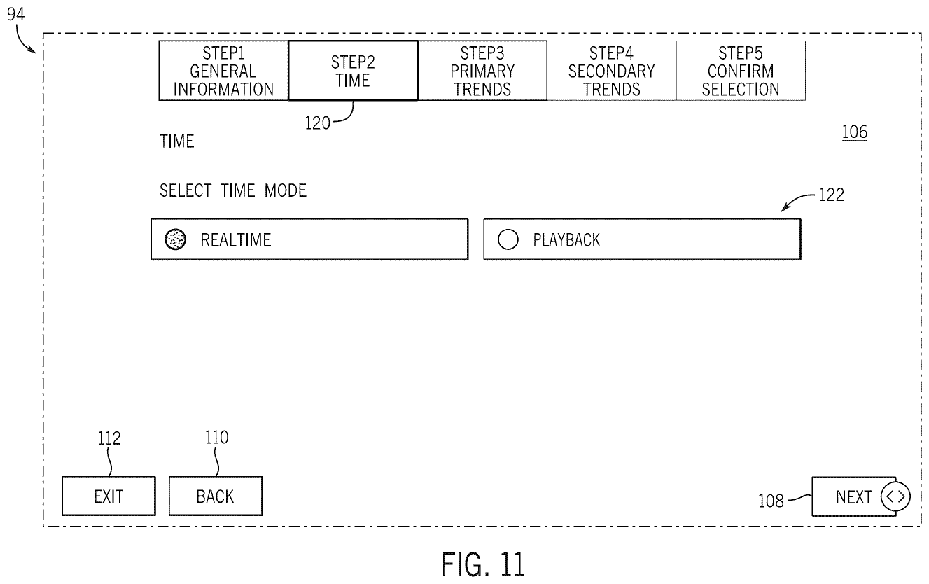

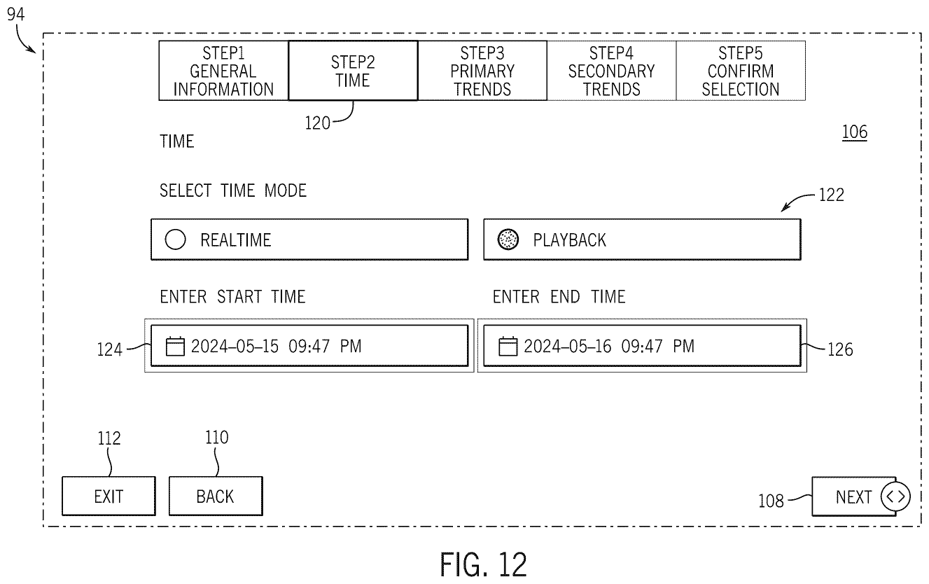

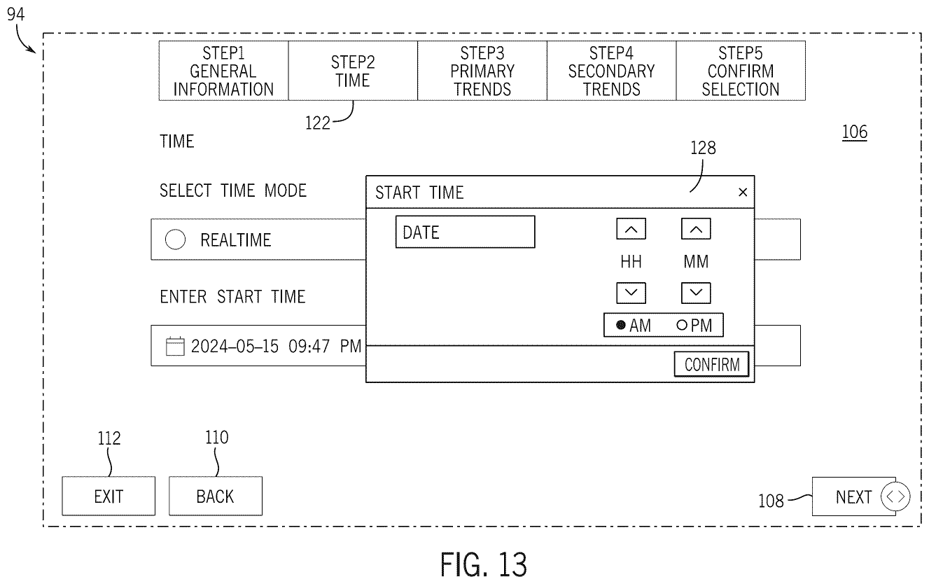

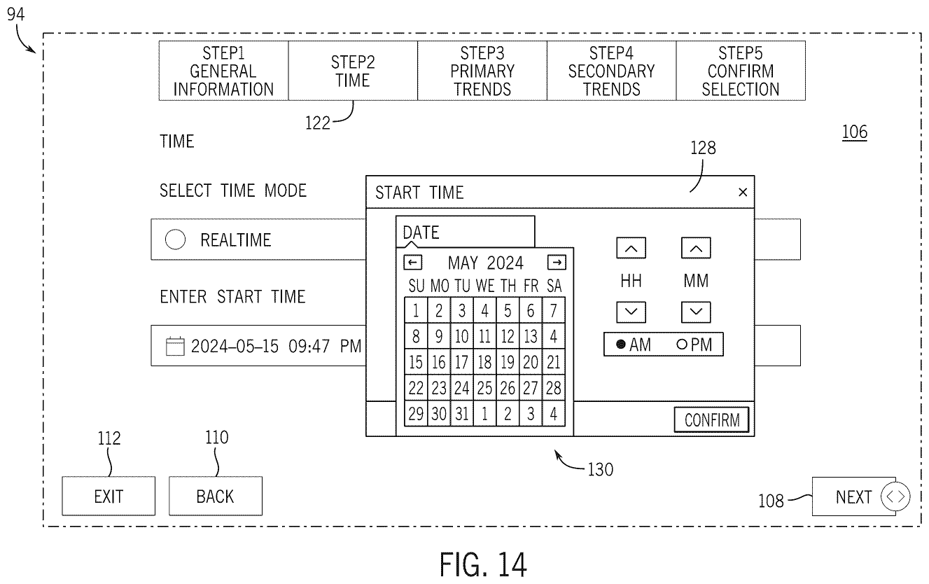

Then, as illustrated in FIGS. 11-14, once the soak test options are selected, the user may select the test time mode in a Time portion 120 of the Configuration process 106. For example, as illustrated in FIG. 11, the user may first select between Realtime (e.g., for realtime testing on data as it is collected during the soak testing) or PlayBack (e.g., for testing on historical data) with Select time mode radio buttons 122. As illustrated in FIGS. 12-14, when PlayBack mode is selected, the user may select the start and end times for the soak test by clicking on respective Start Time and End Time date selection boxes 124, 126, respectively. As illustrated in FIGS. 13 and 14, clicking on either date selection boxes 124, 126 (e.g., Start Time in the illustrated embodiment) will bring up a date/time selection menu 128 where a date and time may be entered, including a calendar view date selector 130.

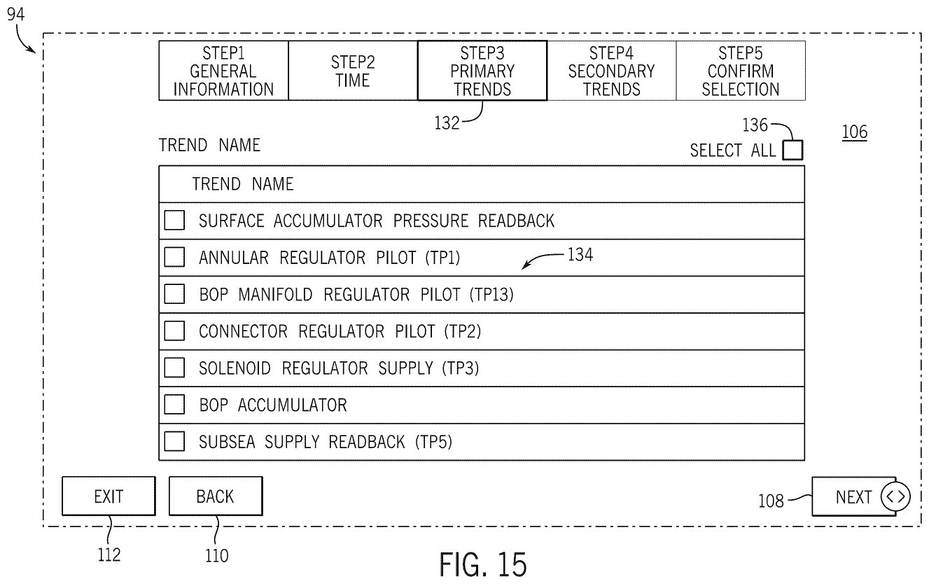

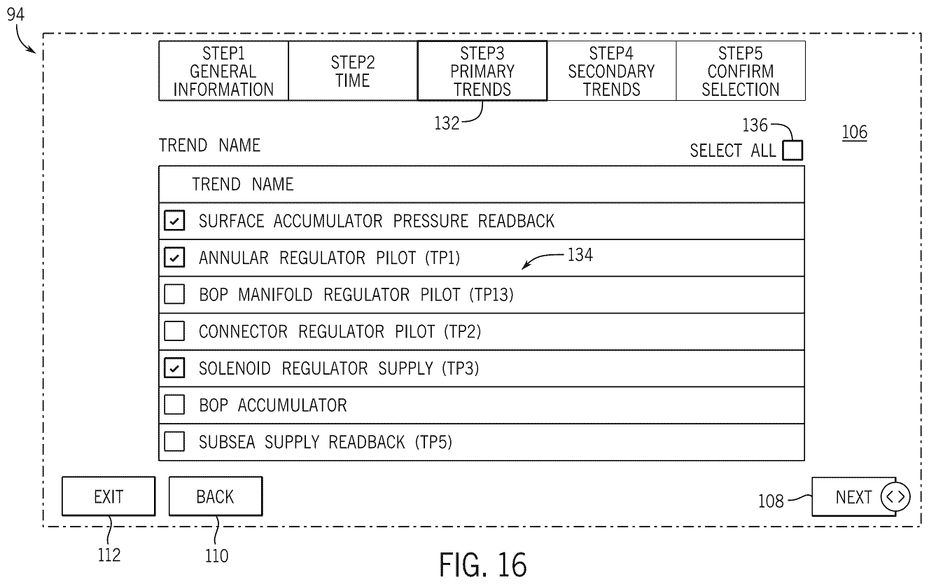

Then, as illustrated in FIGS. 15 and 16, once the test time mode is selected, the user may select primary trends that the user wants to monitor during the soak test in a Primary Trends portion 132 of the Configuration process 106. In particular, the user may select any number of primary trends to be monitored during the soak test from a plurality of Trend Name check boxes 134. In the illustrated embodiment, the primary trends that may be selected may include Pressure Accumulator Pressure Readback, Annular Regulator Pilot, BOP Manifold Regulator Pilot, Connector Regulator Pilot, Solenoid Regulator Supply, BOP Accumulator, and Subsea Supply Readback. However, other primary trends may be selectable in other embodiments. As also illustrated, in certain embodiments, a Select All checkbox 136 may also be used to quickly select all primary trends to be monitored.

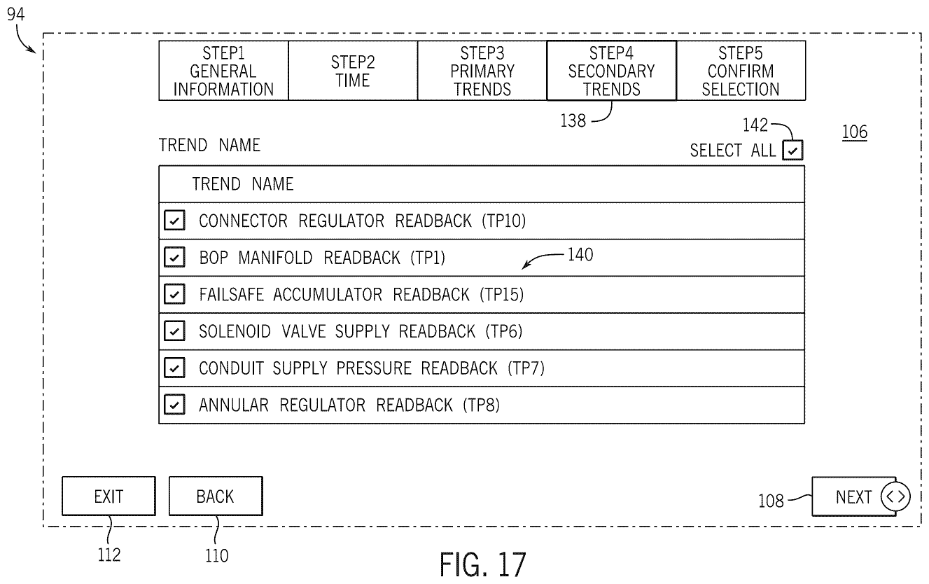

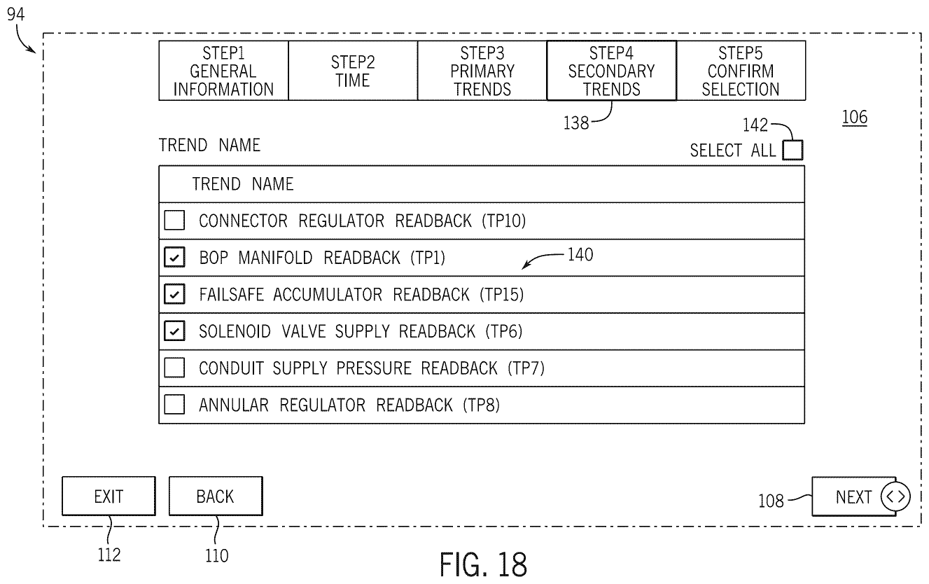

Then, as illustrated in FIGS. 17 and 18, once the primary trends are selected, the user may select secondary trends that the user wants to monitor during the soak test in a Secondary Trends portion 138 of the Configuration process 106. In particular, the user may select any number of secondary trends to be monitored during the soak test from a plurality of Trend name check boxes 140. In the illustrated embodiment, the secondary trends that may be selected may include Connector Regulator Readback, BOP Manifold Readback, Failsafe Accumulator Readback, Solenoid Valve Supply Readback, Conduit Supply Pressure Readback, and Annular Regulator Readback. However, other secondary trends may be selectable in other embodiments. As also illustrated, in certain embodiments, a Select All checkbox 142 may also be used to quickly select all secondary trends to be monitored.

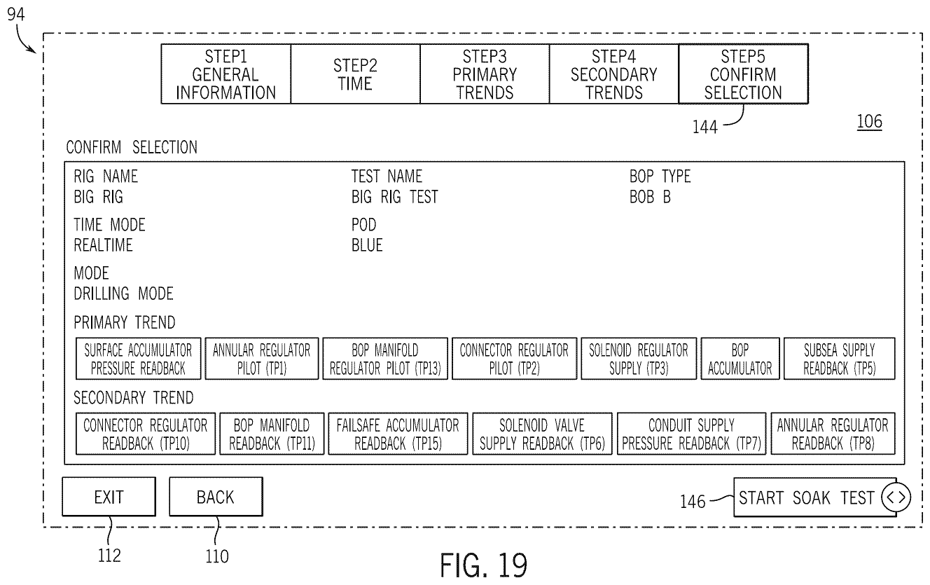

Then, as illustrated in FIG. 19, the summary of selections that were selected during the Configuration process 106 may be reviewed by the user in a Confirm Selection portion 144 of the Configuration process 106. If the user wants to proceed with the selections, the user can click on a Start Soak Test button 146.

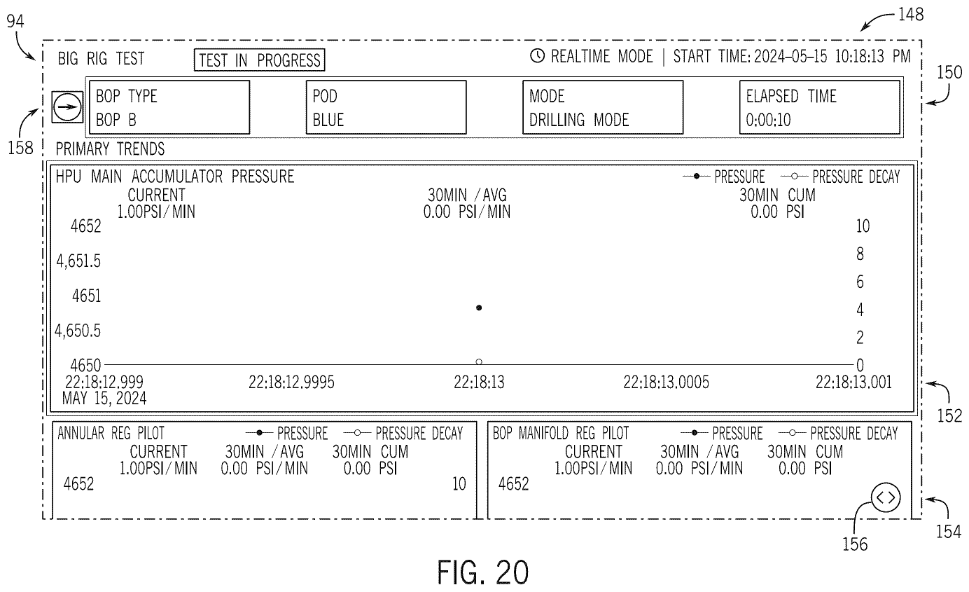

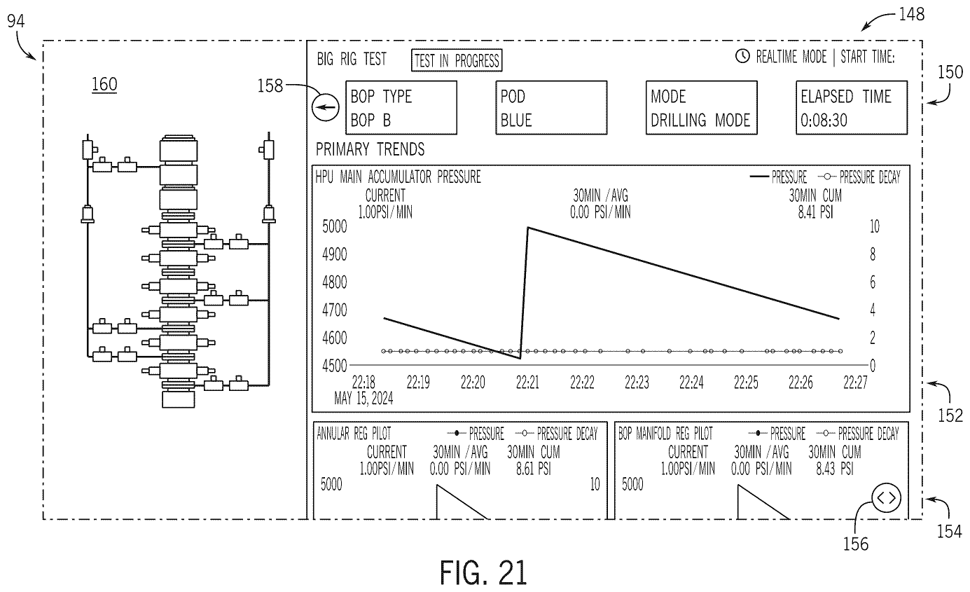

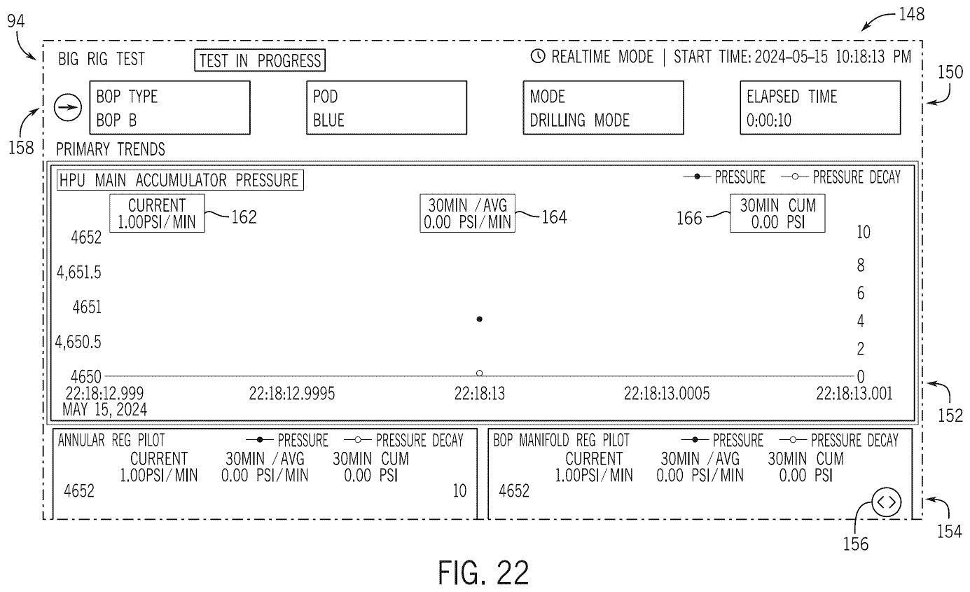

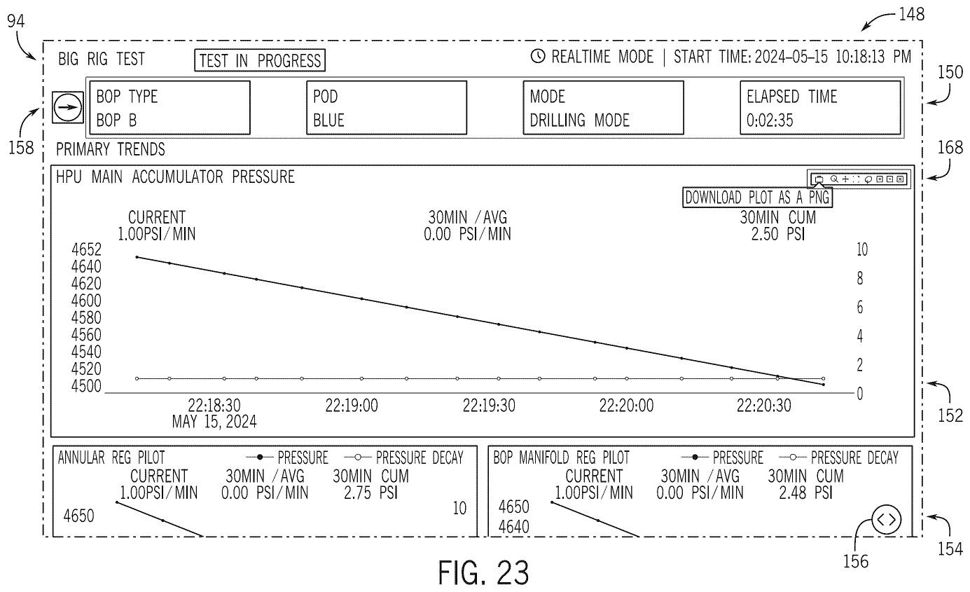

Once the user has approved the selections, as illustrated in FIG. 20, a soak test screen 148 may be presented. As illustrated, the General Information 150 selected by the user for the soak test may be presented near the top of the soak test screen 148. In addition, pressure, pressure decays, and other KPIs may be presented in a main test parameter pane 152 for a currently selected primary or secondary trend (e.g., HPU Main Accumulator Pressure in the illustrated embodiment), which may be scrolled through and selected in a primary/secondary trend selection pane 154 that includes one or more arrows 156 for scrolling through the selected primary and secondary trends. The user may also click on a button 158 to show a snapshot visual view of the BOP being tested in a BOP view pane 160, as illustrated in FIG. 21. Certain KPIs, including current pressure decay 162, 30 minute average pressure 164, and cumulative 30 minute pressure 166, are presented near the top of the main test parameter pane 152 for the currently selected primary or secondary trend, as illustrated in FIG. 22. The 30 minute average pressure 164 and cumulative 30 minute pressure 166 generally only start updating after 30 minutes of data have accumulated. In addition, as illustrated in FIG. 23, hovering over the top right corner of the main test parameter pane 152 presents a plurality of options 168 for the user, including saving an image of the current state of the currently selected primary or secondary trend in the main test parameter pane 152.

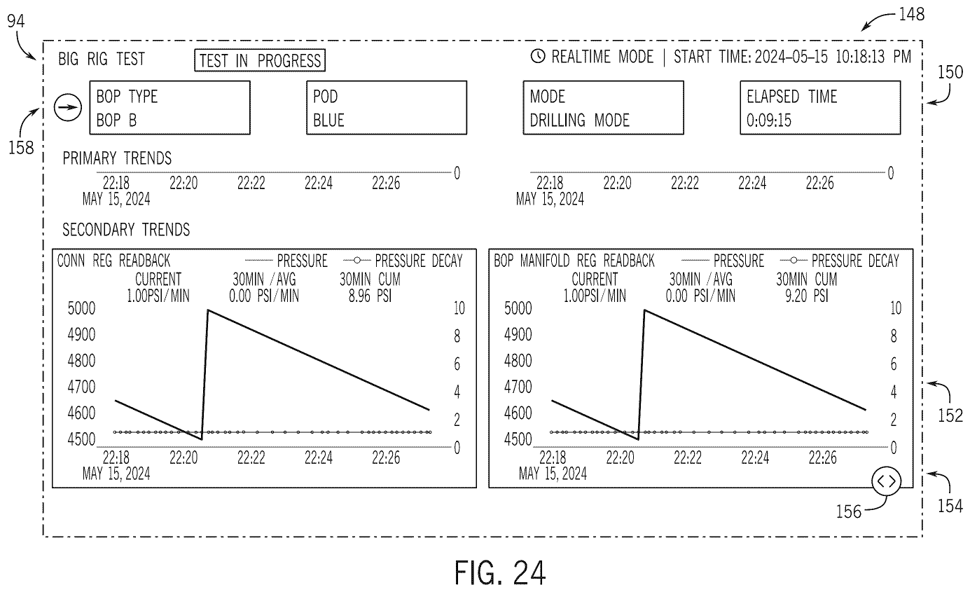

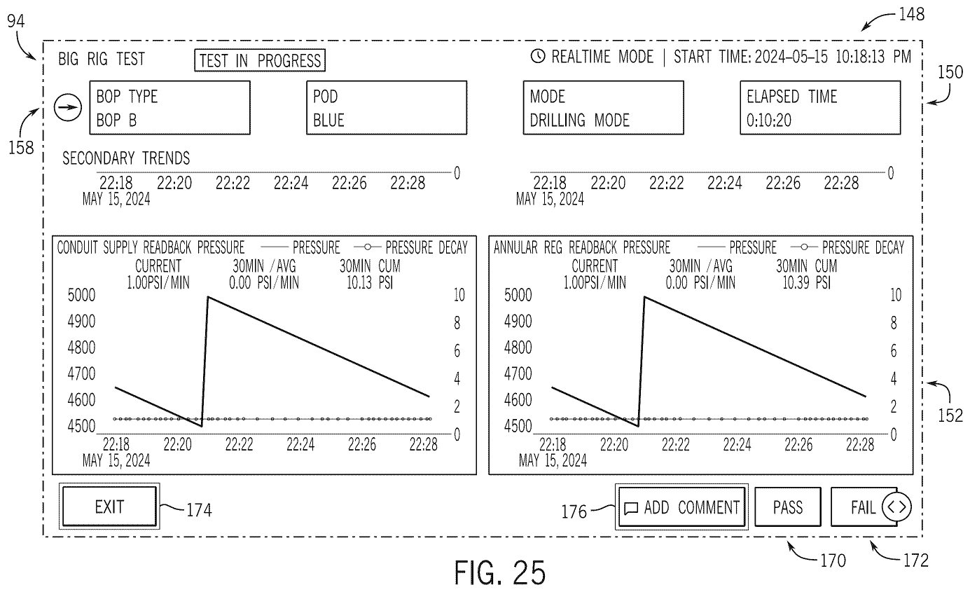

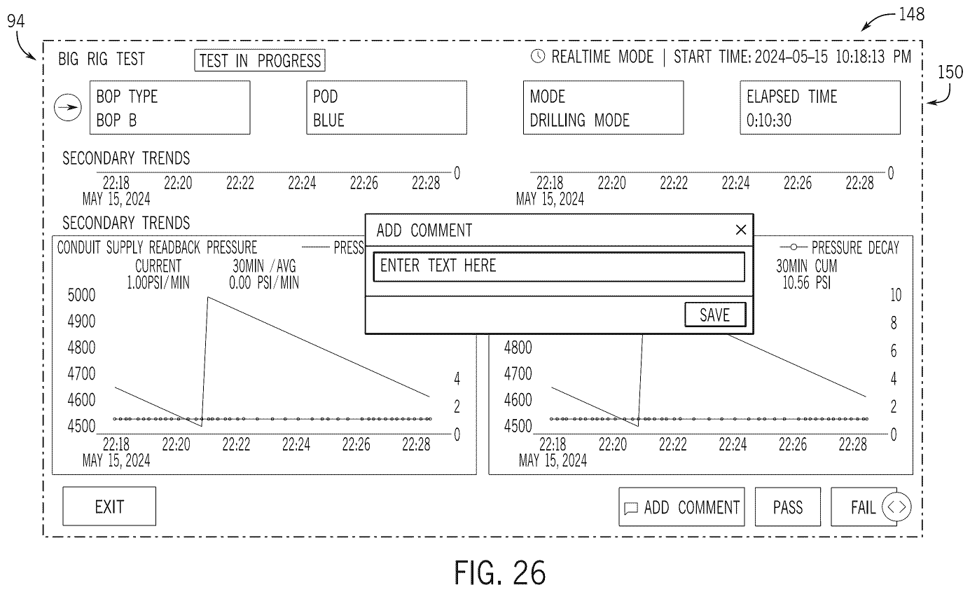

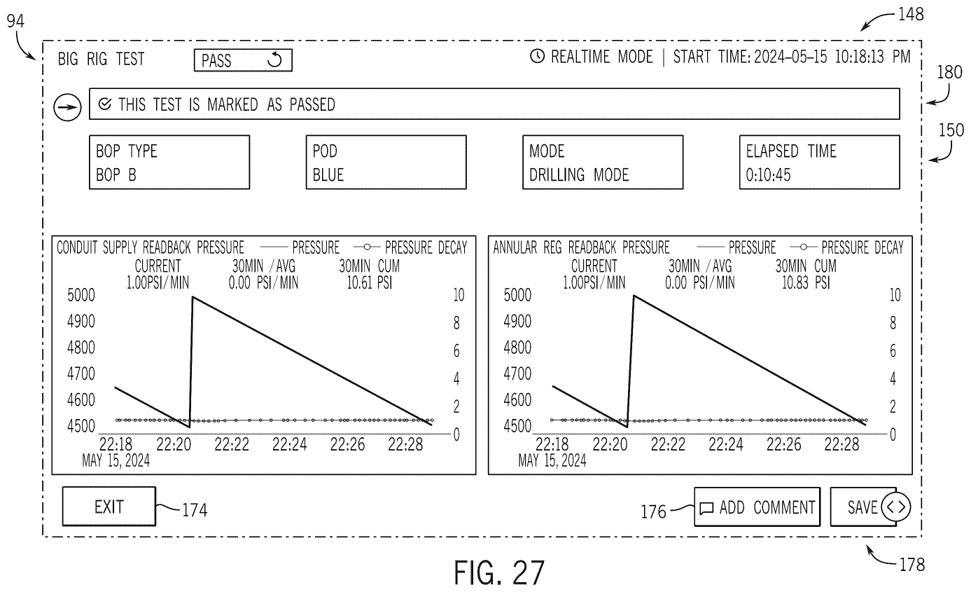

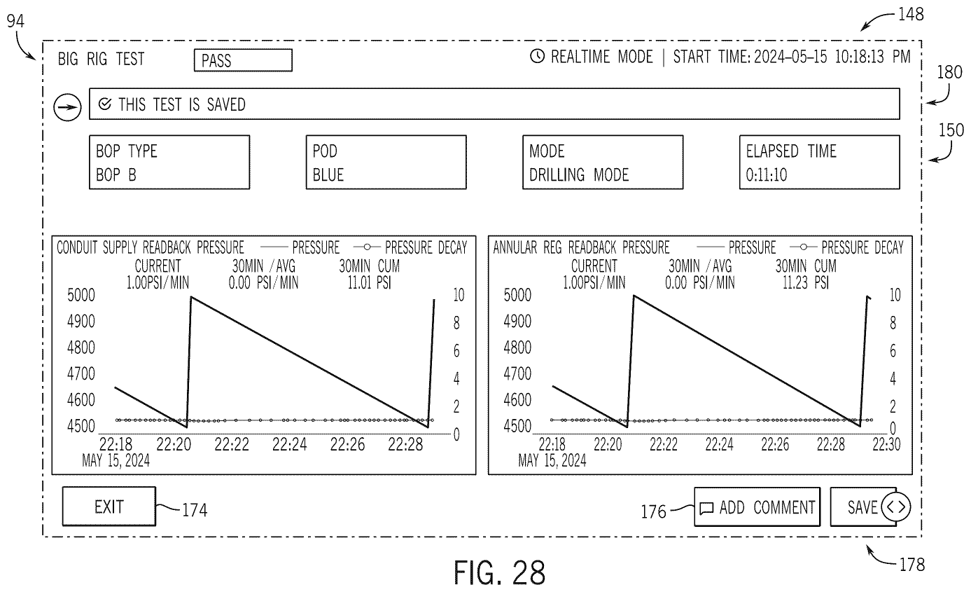

In addition, scrolling down on the main test parameter pane 152 enables the user to vertically scroll through the primary and secondary trends, as illustrated in FIG. 24. Scrolling all of the way to the bottom of the main test parameter pane 152 shows a plurality of other options for the user, including selecting whether the current soak test passed or failed, or exiting the current soak test via respective buttons 170, 172, 174, as illustrated in FIG. 25. In addition, clicking on a comment button 176 enables the user to enter comments for the current soak test, as illustrated in FIG. 26. Clicking on the Pass or Fail buttons 170, 172 causes a Save button 178 to be presented, as well as displaying a banner 180 that indicates whether the current soak test passed or failed, as illustrated by FIG. 27. Then, clicking on the Save button 178 causes the banner 180 to instead indicate that data relating to the current soak test was saved, as illustrated by FIG. 28. It will be appreciated that, in certain embodiments, the data analytics performed on the operational data may provide a preliminary determination of whether the current soak test passed or failed, and a user may either accept this preliminary determination or override it.

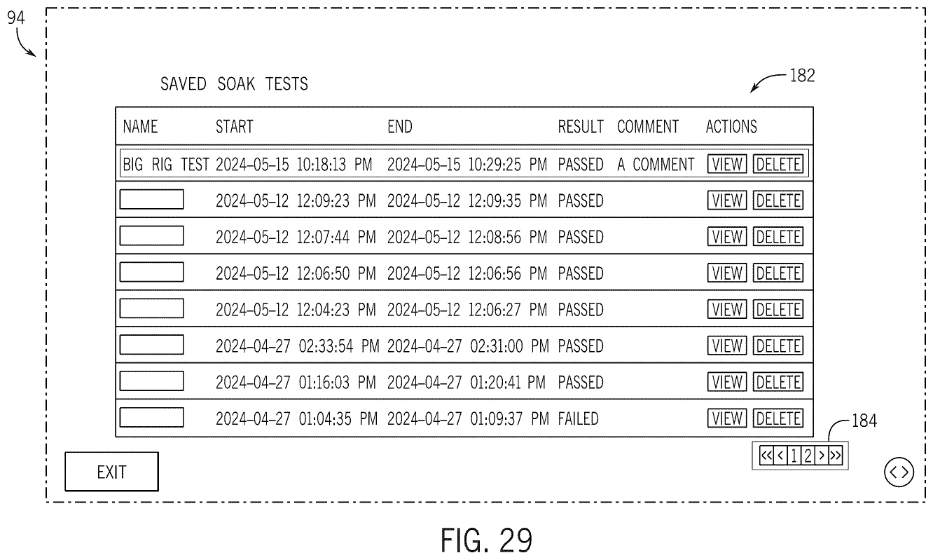

Returning now to FIG. 6, if the user elects to load a previous soak test by clicking on the Saved Soak Test button 98, a table 182 of previous soak tests may be displayed with name of the soak test, start time of the soak test, end time of the soak test, the result (e.g., passed or failed) of the soak test, a comment for the soak test, and actions (e.g., view or delete) that can be taken for the soak test, as illustrated by FIG. 29. As illustrated, these actions may also enable the user to generate a report (e.g., a portable document format (PDF) file) of the results of certain soak tests. In addition, buttons 184 that enable additional various functions, such as enabling the user to change the layout of the soak test screen 148, may be presented.

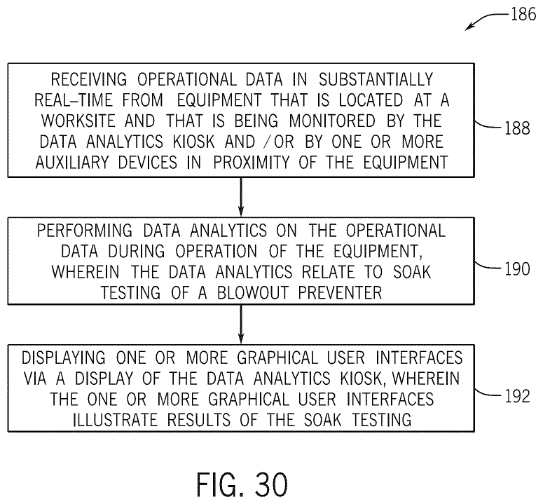

FIG. 30 is a flow diagram of a method 186 for enabling the soak testing described in greater detail herein. As illustrated in FIG. 30, in certain embodiments, the method 186 includes receiving operational data in substantially real-time from equipment 10 that is located at a worksite 36 and that is being monitored by the data analytics kiosk 34 and/or by one or more auxiliary devices 38 in proximity of the equipment 10 (block 188). In addition, in certain embodiments, the method 186 includes performing data analytics on the operational data during operation of the equipment 10, wherein the data analytics relate to soak testing of a blowout preventer (block 190). In addition, in certain embodiments, the method 186 includes displaying one or more graphical user interfaces via a display 80 of the data analytics kiosk 34, wherein the one or more graphical user interfaces illustrate results of the soak testing (block 192).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. § 112 (f). However, for any claims containing elements designated in any other manner, it is intended that such elements are not to be interpreted under 35 U.S.C. § 112 (f).

1. An equipment monitoring system, comprising:
a real-time operations center configured to:
receive operational data in substantially real-time from equipment that is located at a worksite and that is being monitored by the real-time operations center and/or by one or more auxiliary devices in proximity of the equipment;
perform data analytics remotely on the operational data during operation of the equipment, wherein the data analytics relate to soak testing of a blowout preventer (BOP); and
provide one or more graphical user interfaces to one or more computing devices, wherein the one or more graphical user interfaces illustrate results of the soak testing.

2. The equipment monitoring system of claim 1, wherein the real-time operations center is configured to generate a report of the results of the soak testing.

3. The equipment monitoring system of claim 1, wherein the real-time operations center is configured to enable a user to select a drilling mode for the blowout preventer from a plurality of drilling modes for the soak testing.

4. The equipment monitoring system of claim 3, wherein the plurality of drilling modes comprise a drilling mode, a non-drilling mode HP shear, a non-drilling mode with pipe, a non-drilling mode without pipe, and a vent mode.

5. The equipment monitoring system of claim 1, wherein the real-time operations center is configured to enable a user to select between a realtime mode and a playback mode for the soak testing.

6. The equipment monitoring system of claim 1, wherein the real-time operations center is configured to enable a user to select one or more primary trends for the blowout preventer from a plurality of primary trends for the soak testing.

7. The equipment monitoring system of claim 6, wherein the plurality of primary trends comprise a pressure accumulator pressure readback, an annular regulator pilot, a BOP manifold regulator pilot, a connector regulator pilot, a solenoid regulator supply, a BOP accumulator, and a subsea supply readback.

8. The equipment monitoring system of claim 6, wherein the real-time operations center is configured to enable a user to select one or more secondary trends for the blowout preventer from a plurality of secondary trends for the soak testing.

9. The equipment monitoring system of claim 8, wherein the plurality of secondary trends comprise a connector regulator readback, a BOP manifold readback, a failsafe accumulator readback, a solenoid valve supply readback, conduit supply pressure readback, and an annular regulator readback.

10. The equipment monitoring system of claim 1, wherein the real-time operations center is configured to illustrate a snapshot visual view of the BOP being tested in addition to the results of the soak testing via the one or more graphical user interfaces.

11. A data analytics kiosk, comprising:
at least one processor and at least one memory medium, wherein the at least one processor is configured to execute computer-readable instructions stored in the at least one memory medium that, when executed by the at least one processor cause the data analytics kiosk to:
receive operational data in substantially real-time from equipment that is located at a worksite and that is being monitored by the data analytics kiosk and/or by one or more auxiliary devices in proximity of the equipment;
perform data analytics on the operational data during operation of the equipment, wherein the data analytics relate to soak testing of a blowout preventer (BOP); and
display one or more graphical user interfaces via a display of the data analytics kiosk, wherein the one or more graphical user interfaces illustrate results of the soak testing.

12. The data analytics kiosk of claim 11, wherein the at least one processor is configured to execute the computer-readable instructions stored in the at least one memory medium that, when executed by the at least one processor cause the data analytics kiosk to generate a report of the results of the soak testing.

13. The data analytics kiosk of claim 11, wherein the at least one processor is configured to enable a user to select a drilling mode for the blowout preventer from a plurality of drilling modes for the soak testing.

14. The data analytics kiosk of claim 13, wherein the plurality of drilling modes comprise a drilling mode, a non-drilling mode HP shear, a non-drilling mode with pipe, a non-drilling mode without pipe, and a vent mode.

15. The data analytics kiosk of claim 11, wherein the at least one processor is configured to enable a user to select between a realtime mode and a playback mode for the soak testing.

16. The data analytics kiosk of claim 11, wherein the at least one processor is configured to enable a user to select one or more primary trends for the blowout preventer from a plurality of primary trends for the soak testing.

17. The data analytics kiosk of claim 16, wherein the plurality of primary trends comprise a pressure accumulator pressure readback, an annular regulator pilot, a BOP manifold regulator pilot, a connector regulator pilot, a solenoid regulator supply, a BOP accumulator, and a subsea supply readback.

18. The data analytics kiosk of claim 16, wherein the at least one processor is configured to enable a user to select one or more secondary trends for the blowout preventer from a plurality of secondary trends for the soak testing.

19. The data analytics kiosk of claim 18, wherein the plurality of secondary trends comprise a connector regulator readback, a BOP manifold readback, a failsafe accumulator readback, a solenoid valve supply readback, conduit supply pressure readback, and an annular regulator readback.

20. The data analytics kiosk of claim 11, wherein the at least one processor is configured to illustrate a snapshot visual view of the BOP being tested in addition to the results of the soak testing via the one or more graphical user interfaces.
